(19) United States
(12) Patent Application Publication
(10) Pub. No.: US 2025/0013977 A1
(43) Pub. Date: Jan. 9, 2025

(54) METHOD FOR MANAGING DELIVERY BOX

(71) Applicant: TOYOTA JIDOSHA KABUSHIKI KAISHA, Aichi-ken (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(21) Appl. No.: 18/760,016

(22) Filed: Jul. 1, 2024

(30) Foreign Application Priority Data
Jul. 4, 2023 (JP) 2023-110008

(51) Int. Cl. G06Q 10/0836

(52) U.S. Cl. CPC G06Q 10/0836

(57) ABSTRACT

A method for managing a delivery box located at a predetermined receiving station is provided. The delivery box includes storage sections and locks. The storage sections are each configured to store a package. The locks are each configured to lock and unlock a corresponding one of the storage sections. The method for managing the delivery box includes determining, with a control device, whether a replacement execution condition is satisfied. The replacement execution condition is satisfied when the number of storage sections that store packages in the delivery box located at the receiving station is less than or equal to a predetermined number. When the replacement execution condition is satisfied, the method further includes sending, with the control device, to a terminal of an operator an instruction to replace the delivery box located at the receiving station with a new delivery box.

### CROSS-REFERENCE TO RELATED APPLICATIONS

This application is based upon and claims the benefit of priority from prior Japanese Patent Application No. 2023-110008, filed on Jul. 4, 2023, the entire contents of which are incorporated herein by reference.

### BACKGROUND

### 1. Field

The following description relates to a method for managing a delivery box.

### 2. Description of Related Art

Japanese Laid-Open Patent Publication No. 2022-90551 discloses an example of a delivery system that uses a self-driving delivery box capable of traveling between a delivery base, from which a package is delivered, and a receiving station, at which a user receives the package. The delivery box includes a storage section that stores a package and an authentication unit that permits opening of a door of the storage section. At the receiving station, a user opens the door of the delivery box and retrieves a package addressed to the user.

In such a delivery system, there is a need for appropriately managing the delivery box located at the receiving station.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for managing a delivery box located at a predetermined receiving station is provided. The delivery box includes storage sections and locks. The storage sections are each configured to store a package. The locks are each configured to lock and unlock a corresponding one of the storage sections. The method includes determining, with processing circuitry, whether a replacement execution condition is satisfied. The replacement execution condition is satisfied when the number of storage sections that store packages in the delivery box located at the receiving station is less than or equal to a predetermined number. When the replacement execution condition is satisfied, the method further includes sending, with the processing circuitry, to a terminal of an operator an instruction to replace the delivery box located at the receiving station with a new delivery box.

Other features and aspects will be apparent from the following detailed description, the drawings, and the claims.

### BRIEF DESCRIPTION OF THE DRAWINGS

FIG. 1 is a schematic diagram showing a delivery management system in accordance with a first embodiment.

FIG. 2 is a schematic side view showing a delivery box shown in FIG. 1.

FIG. 3 is a schematic side view showing the configuration of a storage section shown in FIG. 2.

FIG. 4 is a block diagram showing the electrical configuration of the delivery management system shown in FIG. 1.

FIG. 5 is a flowchart illustrating processes related to a method for managing a delivery box in accordance with the delivery management system shown in FIG. 1.

FIG. 6 is a flowchart illustrating processes related to a method for managing a delivery box in accordance with a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

A method for managing a delivery box 20 according to a first embodiment will now be described with reference to the drawings.

### Basic Configuration of Delivery Management System

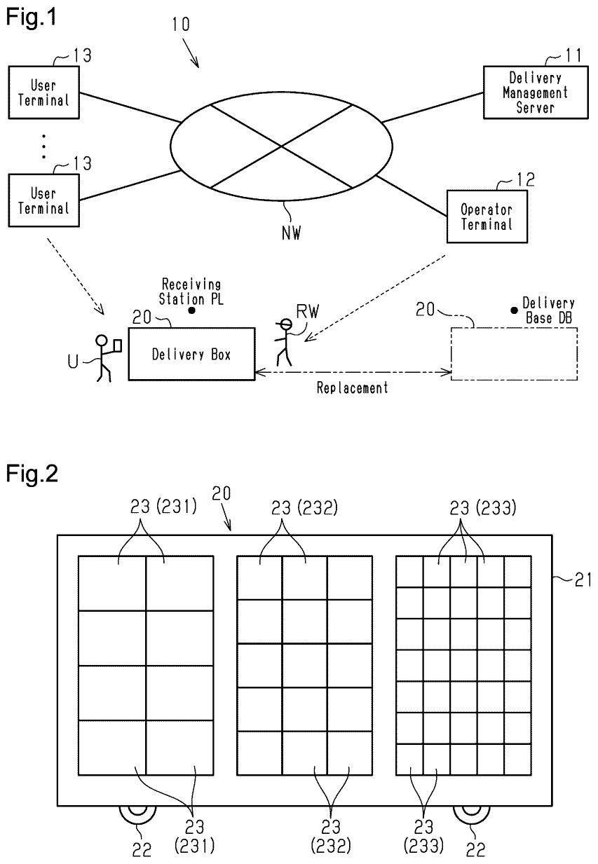

The configuration of a delivery management system 10 will now be described with reference to FIG. 1. As shown in FIG. 1, the delivery management system 10 includes a delivery box 20 and a delivery management server 11. The delivery management server 11 is connected to a user terminal 13 through a network NW such as the Internet. The delivery management server 11 stores, in a memory 43 (refer to FIG. 4), contact information such as an email address of a user received from the user terminal 13. When there is a package addressed to a user U, the delivery management server 11 sends to the user terminal 13 of the user U information indicating that there is a package addressed to the user U. The user terminal 13 is a communication device owned by an individual. The user terminal 13 may be, for example, a smartphone, a tablet terminal, or a personal computer.

In the method for managing a delivery box according to the present embodiment, for example, the delivery box 20 accommodating the package addressed the user U is arranged at a receiving station PL near the residence of the user U, who is the recipient of the package. When the user terminal 13 of the user U receives information indicating that there is a package, the user U receives the package addressed to the user U from the delivery box 20 located at the receiving station PL.

The user U, who uses this delivery box package pickup service registers contact information such as an address, a name, and an email addresses in advance. For example, the delivery management server 11 is installed at the delivery base DB. When there is a package addressed to the user U, the delivery management server 11 sends to the contact of the user U information indicating that there is a package addressed to the user U. The method of contacting the customer is not limited to e-mail, and may be any method capable of notifying the user of information, such as phone call, LINE®, or SMS (Short Message Service).

At the delivery base DB, a transport vehicle such as a truck is allocated. The transport vehicle moves the delivery box 20 to the receiving station PL located in each region. The delivery base DB is also a station where packages are collected. Among the collected packages, the package of the user U, who uses the delivery box pickup service, is stored in the delivery box 20 at the receiving station PL. An operator, who is an employee of a delivery company or an employee of a delivery box transportation contractor, moves the delivery box 20 from the delivery base DB to the receiving station PL, for example, by a transport vehicle. The user U picks up the package addressed to the user U from the delivery box 20 located at a predetermined receiving station PL during a receiving period. The information indicating that there is a package includes information related to the receiving period.

The delivery box 20 located at the receiving station PL is replaced at regular or irregular intervals. The reason for replacing the delivery box 20 may be to deliver a new package 15 to the receiving station PL, may be to retrieve the package 15 of the user U who did not pick up the package 15 within the receiving period to the delivery base DB, or may be to perform maintenance on the delivery box 20, or the like. The reason for replacing the delivery box 20 may be, for example, a reason that, when the number of packages 15 to be delivered on the day or the next day is large, operators store the packages 15 in a new delivery box 20 at the delivery base DB in advance and then deliver the new delivery box 20 to the receiving station PL. The replacement of the delivery box 20 may be performed by moving the new delivery box 20 from the delivery base DB to the receiving station PL and moving the old delivery box 20 from the receiving station PL to the delivery base DB. In the example shown in FIG. 1, an operator RW, for example, delivers and replaces the delivery box 20.

### Configuration of Delivery Box 20

The configuration of the delivery box 20 will now be described with reference to FIG. 2. As shown in FIG. 2, the delivery box 20 may be, for example, configured to travel. The delivery box 20, which is a travel type, includes a main body 21 and wheels 22. The main body 21 of the delivery box 20 includes storage sections 23 each configured to store a package. An example of the storage section 23 is a locker. The storage sections 23 differ in size and volume in accordance with dimensions of packages. The storage sections 23 include, for example, a first storage section 231, a second storage section 232, and a third storage section 233. The first storage section 231 stores a large package. The second storage section 232 stores a middle-sized package. The third storage section 233 stores a small package. The storage sections 23 may include a storage section having a volume that allows for storage of a package having a size that differs from the above. The storage sections 23 may include a storage section that also differs in shape, in addition to volume. The storage sections 23 may include a storage section configured to store an elongated package.

The travel-type delivery box 20 shown in FIG. 2 may be a self-driving type or a towing type. In the case of the towing type, a transport vehicle tows and moves the delivery box 20. In the case of the self-driving type, the delivery box 20 may include a driver seat. The delivery box 20 may be a stationary type without the wheels 22. For example, an operator places the stationary-type delivery box 20 on a platform of a transport vehicle and moves the delivery box 20.

### Configuration of Storage Section 23

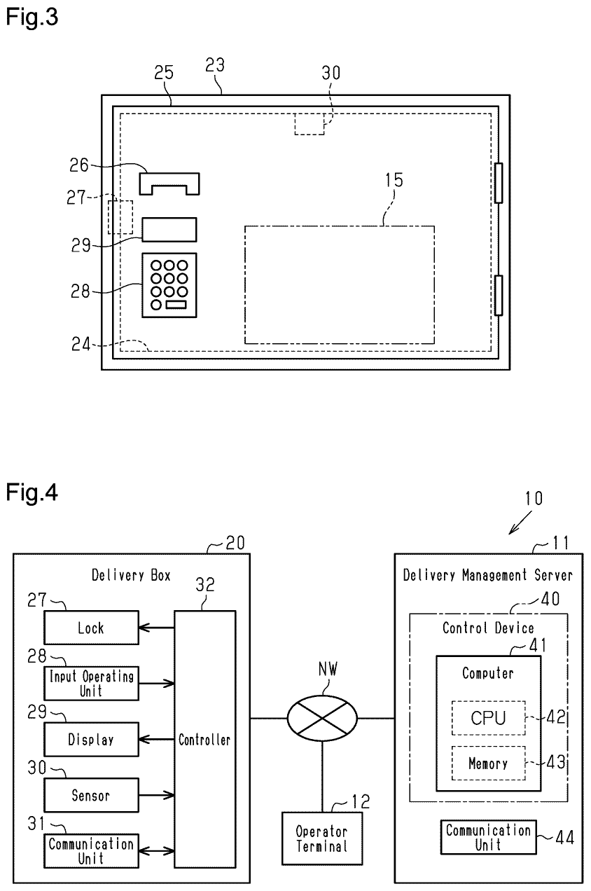

The configuration of the storage section 23 will now be described with reference to FIG. 3.

As shown in FIG. 3, the storage section 23 includes a storage compartment 24 and a door 25. The storage compartment 24 is configured to store the package 15. The door 25 is configured to open and close the storage compartment 24. The door 25 includes a knob 26 that can be held by the user U. The delivery box 20 includes a lock 27 configured to lock and unlock the storage section 23. The lock 27 may be operated, for example, by entering a password or a personal identification number using a keypad. For example, the user U, who is a customer, may set the password or the personal identification number when registering to the service. Alternatively, the password or the personal identification number may be set separately for each package, as one piece of information included in package information that is sent from the delivery management server 11.

As shown in FIG. 3, the door 25 includes an input operating unit 28 which is operated when the user U inputs a password or a personal identification number, and a display 29 which displays the input password or personal identification number. The display 29 may display various messages, such as an operation instruction, in addition to the input content. The input operating unit 28 may include a plurality of mechanical operation buttons, or may include a touch panel type operation button which is displayed as an image on a touch panel and can be input by a touch operation by the user U.

The storage section 23 shown in FIG. 3 includes a sensor 30 capable of detecting whether the package 15 is stored in the storage compartment 24. The sensor 30 is used to determine whether the package 15 is taken out from the storage section 23. The sensor 30 is of a non-contact type, and detects whether the package 15 is in the storage section 23. The detection result of the sensor 30 is sent to the delivery management server 11 at the delivery base DB through wireless communication.

### Electrical Configuration of Delivery Management System 10

The electrical configuration of the delivery management system 10 will now be described with reference to FIG. 4. As shown in FIG. 4, the delivery box 20 includes a controller 32. An example of the controller 32 is an electronic control device. The lock 27, the input operating unit 28, the display 29, the sensor 30, and a communication unit 31 are electrically connected to the controller 32. The controller 32 displays lock information input by the user U operating the input operating unit 28 on the display 29. When the lock information is input, the controller 32 performs an authentication process. When the lock information is authenticated, the controller 32 unlocks the electric lock 27.

The sensor 30 determines whether the package 15 is taken out from the storage section 23. The detection result of the sensor 30 is sent to the delivery management server 11 via the communication unit 31 and the network NW. The delivery management server 11 obtains the reception status of the package 15 in the delivery box 20 based on the detection result of the sensor 30.

An operator terminal 12, which is an example of a terminal of an operator, is connected to the network NW in a manner allowing for communication. The operator terminal 12 is, for example, a mobile terminal such as a smartphone carried by an operator who delivers and replaces the delivery box 20. The delivery management server 11 instructs the operator to move and replace the delivery box 20 via the operator terminal 12.

As shown in FIG. 4, the delivery management server 11 includes a control device 40. The control device 40 includes a computer 41. The computer 41 includes a central processing unit (CPU) 42 and a memory 43. The memory 43 stores a delivery management program (not shown). The computer 41 executes the delivery management program to control delivery instructions for moving the delivery box 20 to the receiving station PL and the delivery base DB, and to manage the package 15 in the delivery box 20. The delivery management server 11 includes a communication unit 44. The delivery management server 11 performs communication through the network NW with the delivery box 20, the operator terminal 12, and the user terminal 13 via the communication unit 44.

The control device 40 is not limited to processing circuitry that performs all software processing of the processes executed by the control device 40. For example, the control device 40 may be processing circuitry including a dedicated hardware circuit (for example, an application specific integrated circuit (ASIC)) that performs hardware processing of at least part of the processes executed by the control device 40. That is, the control device 40 may be processing circuitry including one or more processors that operate according to a computer program (software), one or more dedicated hardware circuits that execute at least part of various types of processes, or a combination of the above. The processor includes a CPU and a memory, such as a random-access memory (RAM) or a read-only memory (ROM). The memory stores program codes or commands configured to cause the CPU execute processes. The memory, which is a computer readable medium, may be any available medium that is accessible by a versatile or dedicated computer.

A method performed by the control device 40 to manage the delivery box 20 located at a predetermined receiving station PL will now be described. The method performed by the control device 40 to manage the delivery box 20 includes following steps (a) and (b).
(a) The control device 40 determines whether a replacement execution condition is satisfied. The replacement execution condition is satisfied when the number RN of storage sections 23 that store the packages 15 in the delivery box 20 located at the receiving station PL is less than or equal to a predetermined number N1.
(b) When the replacement execution condition is satisfied, the control device 40 sends to the terminal of an operator (operator terminal 12) an instruction to replace the delivery box 20 located at the receiving station PL with a new delivery box 20.

The number of empty storage sections 23 in the new delivery box 20 is greater than or equal to the predetermined number N1. The predetermined number N1 is set such that the remaining packages 15 in the old delivery box 20 can be transferred to the new delivery box 20. As shown in FIG. 2, the delivery box 20 of the present embodiment includes different (for example, three) types of storage sections 23 having different volumes. In order to transfer the packages 15 remaining in the old delivery box 20 to the new delivery box 20, the new delivery box 20 should include the storage sections 23 having volumes that correspond to the dimensions of the packages 15 still stored in the old delivery box 20. Thus, in the present embodiment using the delivery box 20 shown in FIG. 2, the control device 40 determines whether the number RN of occupied storage sections 23 is less than or equal to the predetermined number N1 for each volume type of the storage sections 23 that still store the packages 15 in the old delivery box 20. For example, the new delivery box 20 has empty storage sections 23, specifically, the number of large first storage sections 231 is N11, the number of meddle-sized second storage sections 232 is N12, and the number of small third storage sections 233 is N13. The control device 40 determines, as the replacement execution condition, the number of occupied storage sections 23 in the old delivery box 20 as follows. The control device 40 determines, as the replacement execution condition, whether the number RN1 of occupied first storage sections 231 is less than or equal to a predetermined number N11, whether the number RN2 of the occupied second storage sections 232 is less than or equal to a predetermined number N12, and whether the number RN3 of occupied third storage sections 233 is less than or equal to a predetermined number N13.

The lock 27 of the delivery box 20 is configured to be unlocked when the lock information is authenticated. The method for managing the delivery box may further include following step (c).
(c) The control device 40 temporarily grants the lock information of the old delivery box 20 to the operator who replaces the old delivery box 20 with the new delivery box 20. The control device 40 sends the lock information of the old delivery box 20 to the terminal 12 of the operator who performs the replacement.

### Operation of First Embodiment

The operation of the method for managing the delivery box 20 in accordance with the first embodiment will now be described with reference to FIGS. 1 to 5.

In the first embodiment, when replacing the delivery box 20, the packages 15 remaining in the old delivery box 20 are transferred to the new delivery box 20. Therefore, the control device 40 performs a determination process for determining whether the new delivery box 20 has empty storage sections to which every one of the remaining packages 15 can be transferred.

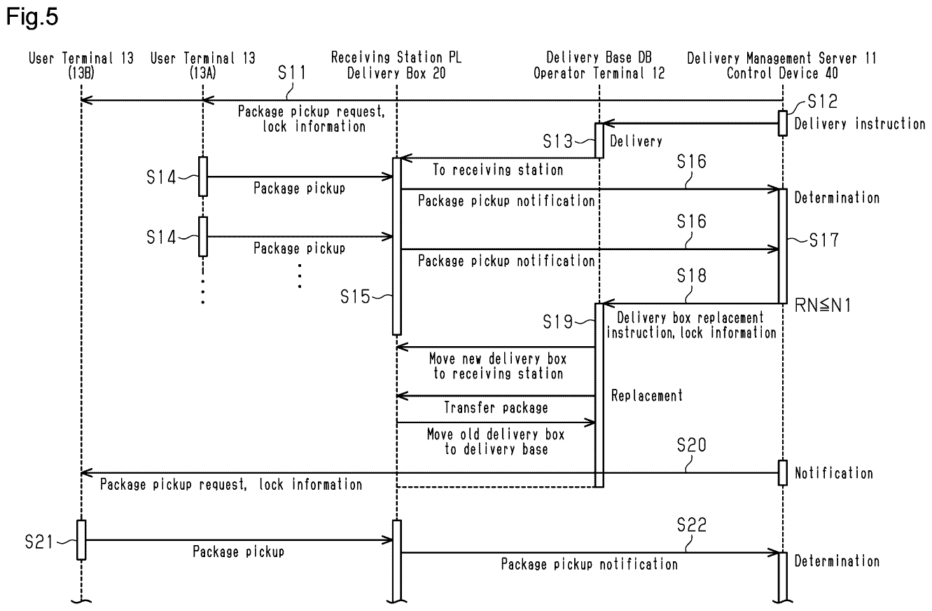

FIG. 5 shows a procedure in the method for managing the delivery box 20 performed between the delivery management server 11 (control device 40), the delivery box 20, the operator terminal 12, and the user terminal 13. In FIG. 5, the user terminal 13 of the users U who received the package 15 within the receiving period is indicated as “user terminal 13A”, and the user terminal 13 of the users U who did not receive the package 15 within the receiving period is indicated as “user terminal 13B”.

First, at the delivery base DB, packages are sorted into packages to be delivered to delivery boxes and packages to be delivered to homes. The packages 15 to be delivered to delivery boxes are sorted for each receiving station PL to which the package is delivered. The packages 15 are stored in the delivery box 20 for each receiving station PL.

As shown in FIG. 5, the control device 40 sends a package pickup request and, if necessary, lock information to the user terminals 13 (step S11). The package pickup request includes package information related to the package addressed to the user. The package information includes the receiving station PL, the receiving period, a delivery box number, a storage section number, a package identification number, package sender information, destination information, or the like. When the lock information is a password or a personal identification number registered in advance by the user U, it is not necessary to send the lock information. For example, when the lock information is set for each package, the lock information is sent to the user.

The control device 40 sends a delivery instruction to the operator terminal 12 (step S12). When the operator RW (refer to FIG. 1) receives the delivery instruction via the operator terminal 12, the operator RW delivers the delivery box 20 to the receiving station PL (step S13). That is, the operator RW moves the delivery box 20 from the delivery base DB to the receiving station PL. For example, the operator RW loads the delivery box 20 on a transport vehicle and transports the delivery box 20 to the receiving station PL. The delivery box 20 may be delivered by towing the travel-type delivery box 20 by a transport vehicle. Alternatively, the operator RW may drive the travel-type delivery box 20 provided with a driver seat.

In this manner, the delivery box 20 is set at the receiving station PL by when the receiving period starts. At a convenient time during the receiving period, the user U goes to the delivery box 20 arranged at the receiving station PL and receives the package 15 addressed to the user U (step S14). For example, the user U inputs the lock information (password or personal identification number) by operating the input operating unit 28 of the storage section 23 to which the designated storage section number is assigned. The controller 32 of the delivery box 20 performs a delivery procedure so that the user U, to whom the package 15 is addressed, correctly receives the package 15 (step S15). Specifically, the controller 32 performs an authentication process of the input lock information. When the lock information is authenticated, the controller 32 unlocks the lock 27 of the storage section 23 to which the authenticated lock information is input. The user U opens the door 25 and takes out the package 15 from the storage compartment 24. Thereafter, the user U closes the door 25. When the door 25 is closed, the controller 32 locks the lock 27. When the package 15 in the storage compartment 24 is taken out, the sensor 30 is switched from a detection state to a non-detection state. The controller 32 determines whether the user U, to whom the package 15 is addressed, received the package 15 by detecting the opening and closing of the door 25 and the presence of the package by the sensor 30. When the controller 32 determines that the user U, to whom the package 15 is addressed, has received the package 15, the controller 32 sends a package pickup notification to the delivery management server 11 (step S16).

Whenever a package pickup notification is received, the control device 40 of the delivery management server 11 determines whether the replacement execution condition, in which the number RN of occupied storage sections 23 in the delivery box 20 is less than or equal to the predetermined number N1, is satisfied (step S17). That is, the control device 40 determines whether the replacement execution condition is satisfied every time a package pickup notification, which indicates that the user U has received the package 15 addressed to the user U from the storage section 23 of the delivery box 20, is received. When the replacement execution condition (RN≤N1) is satisfied, the control device 40 sends a delivery box replacement instruction to the operator terminal 12 together with the lock information (step S18).

The operator RW who received the delivery box replacement instruction with the operator terminal 12 replaces the delivery box 20 (step S19). First, the operator RW moves the new delivery box 20 from the delivery base DB to the receiving station PL. Next, the operator RW transfers the remaining package 15 stored in the old delivery box 20 to the new delivery box 20. At this time, the operator RW unlocks the lock 27 of the storage section 23 by operating the input operating unit 28 to input the lock information. The predetermined number N1 for determining the replacement execution condition is set to a value less than or equal to the number of empty storage sections 23 of the new delivery box 20. Thus, all of the packages 15 remaining in the old delivery box 20 can be transferred to the storage sections 23 of the new delivery box 20. After the packages 15 are transferred, the operator RW moves the old delivery box 20 from the receiving station PL to the delivery base DB. In this manner, the operator RW replaces the old delivery box 20 with the new delivery box 20. After the operator RW replaces the delivery box 20, the operator RW sends transfer information including the delivery box number and the storage section numbers to which the packages 15 are transferred, and the destinations of the transferred packages 15 from the operator terminal 12 to the delivery management server 11.

The control device 40 of the delivery management server 11 sends (resends) the package pickup request and the lock information to the user terminal 13B of the user U who did not come to receive the package (step S20). The user U who did not come to receive the package is identified from the transfer information, for example. The lock information may be sent again if the lock information is set for each package 15. In this case, the lock information may be changed after the package 15 is transferred. The user U who received the package pickup request with the user terminal 13B goes to the receiving station PL and receives the package 15 addressed to the user U from the delivery box 20 (step S21). When the control device 40 receives the package pickup notification from the controller 32 of the delivery box 20, the control device 40 of the delivery management server 11 determines that the user U has received the package 15. The control device 40 also determines whether the replacement execution condition is satisfied for the new delivery box 20 in the same manner.

### Advantages of First Embodiment

The first embodiment has the following advantages.

(1-1) The delivery box 20 includes the storage sections 23 and the lock 27. The storage sections 23 are each configured to store the package 15. The lock 27 is configured to lock and unlock the storage section 23. The method for managing the delivery box 20 located at the predetermined receiving station PL includes following steps (a) and (b). (a) The control device 40 determines whether the replacement execution condition is satisfied. The replacement execution condition is satisfied when the number of storage sections 23 that store the packages 15 in the delivery box 20 arranged at the receiving station PL is less than or equal to the predetermined number N1. (b) When the replacement execution condition is satisfied, the control device 40 sends to the terminal 12 of the operator an instruction to replace the delivery box 20 located at the receiving site PL with a new delivery box 20. This replaces delivery box 20 appropriately.

(1-2) In the method for managing the delivery box 20, the delivery box 20 is replaced when the number of empty storage sections 23 in the new delivery box 20 is greater than or equal to the predetermined number N1. Thus, all of the packages 15 remaining in the old delivery box 20 can be transferred to the new delivery box 20.

(1-3) The lock 27 is configured to be unlocked through authentication of the lock information. The method for managing the delivery box 20 includes following step (c). (c) The control device 40 temporarily grants the lock information of the old delivery box 20 to the operator who replaces the old delivery box 20 with the new delivery box 20. Thus, when the lock 27 of the old delivery box 20 is unlocked, the packages 15 remaining in the old delivery box 20 can be transferred to the new delivery box 20.

### Second Embodiment

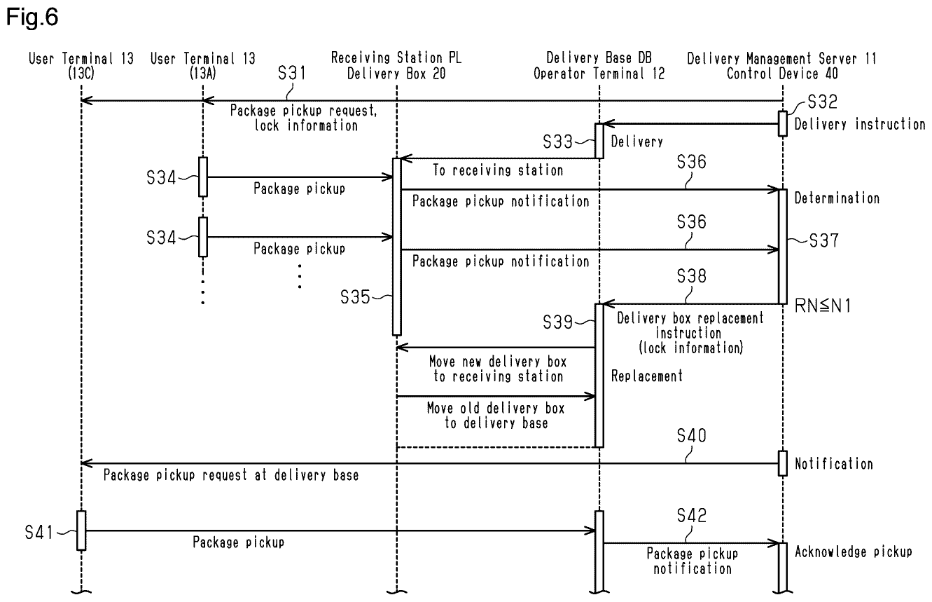

A method for managing the delivery box 20 in accordance with a second embodiment will now be described with reference to FIG. 6. In the first embodiment, the remaining package 15 is transferred to the new delivery box 20. However, in the second embodiment, the package 15 remaining in the old delivery box 20 is brought back to the delivery base DB together with the old delivery box 20 without transferring the package 15. The configuration of the delivery box 20 is the same as that of the first embodiment, but the content of the delivery control performed by the delivery management server 11 differs from that of the first embodiment. In FIG. 6, the user terminal 13 of the users U who received the package 15 within the receiving period is indicated as “user terminal 13A”, and the user terminal 13 of the users U who did not receive the package 15 within the receiving period is indicated as “user terminal 13C”.

The method for managing the delivery box 20 in accordance with the second embodiment includes following steps (d) and (e).
(d) The control device 40 sends to the terminal 12 of the operator an instruction to move the old delivery box 20 from the receiving station PL to the delivery base DB.
(e) The control device 40 notifies the recipient of the package 15 that is still stored in the old delivery box 20 that the package 15 is at the delivery base DB.

The steps S31 to S37 in FIG. 6 are the same as steps S11 to S17 in FIG. 5.

As shown in FIG. 6, in step S37, the control device 40 of the delivery management server 11 determines whether a replacement execution condition is satisfied. The replacement execution condition is satisfied when the number RN of occupied storage sections 23 is less than or equal to the predetermined number N1. When the replacement execution condition (RN≤N1) is satisfied, the control device 40 sends a delivery box replacement instruction to the operator terminal 12 (step S38). At this time, the lock information may be sent together. In the second embodiment, the lock information does not have to be sent since the packages 15 are basically not transferred. The predetermined number N1 corresponds to the number of packages 15 that have not been received by the user U and are to be transferred from the receiving station PL to the delivery base DB. Thus, it is preferred that the predetermined number N1 be set to a value as small as possible. It is preferred that the predetermined number N1 be, for example, a value that is less than or equal to 30% of the total number of storage sections 23 in the delivery box 20, and more preferably, a value that is less than or equal to 20% of the total number.

The replacement execution condition in the second embodiment may include a period condition. For example, the replacement execution condition may be set such that the replacement execution condition is not satisfied during the receiving period in which the user U can pick up the package 15 from the delivery box 20, and that the replacement execution condition is satisfied if the condition of RN≤N1 is satisfied when the receiving period elapses or when a predetermined grace period elapses after the receiving period. This avoids a situation in which the package 15 is moved to the delivery base DB even within the receiving period.

The operator RW who received the delivery box replacement instruction with the operator terminal 12 replaces the delivery box 20 (step S39). That is, the operator RW replaces the old delivery box 20 with the new delivery box 20. Then, the operator RW moves the old delivery box 20 together with the remaining packages 15 to the delivery base DB. When the delivery box 20 contains both the packages 15 within the receiving period and the packages 15 beyond the receiving period, the packages 15 within the receiving period may be transferred to the new delivery box 20, and the packages 15 beyond the receiving period may be moved to the delivery base DB together with the old delivery box 20.

The delivery management server 11 sends a package pickup request at the delivery base DB via the user terminal 13C to the user U who did not come to the delivery box 20 to receive the package 15 (step S40). The user U who received the package pickup request with the user terminal 13C goes to the delivery base DB and receives the package 15 addressed to the user U (step S41). When the package 15 is received, a package pickup notification is sent from the operator terminal 12 to the delivery management server 11. When the delivery management server 11 receives the package pickup notification from the operator terminal 12, the delivery management server 11 acknowledges that the user U has received the package 15.

### Advantages of Second Embodiment

The second embodiment has the following advantages in addition to advantage (1-1) of the first embodiment.

(2-1) The method for managing the delivery box 20 includes the following steps (d) and (e). (d) The control device 40 sends to the terminal 12 of the operator an instruction to move the old delivery box 20 from the receiving station PL to the delivery base DB. (e) The control device 40 notifies the recipient of the package 15 that is still stored in the old delivery box 20 that the package 15 is at the delivery base DB. Thus, the recipient of the package 15, which stored in the old delivery box 20, can receive the package 15 at the delivery base DB.

### Modified Examples

The embodiments are not limited to the ones described above and may be modified as follows.

In the first embodiment, the predetermined number N1 may be changed in accordance with the number of empty storage sections 23 in the new delivery box 20. Alternatively, the predetermined number N1 may be a fixed value.

The controller 32 of the delivery box 20 may function as an example of the control device. For example, the controller 32 may receive information on the predetermined number N1 from the delivery management server 11. The controller 32 may count the number RN of occupied storage sections 23 storing the packages 15 that have not been received by the user U based on the detection result of the sensor 30. The controller 32 may determine whether the replacement execution condition RN≤N1 is satisfied. When the replacement execution condition is satisfied, the controller 32 may send an instruction to replace the delivery box 20 to the terminal 12 of the operator. Alternatively, the control device 40 of the delivery management server 11, which received information indicating that the replacement execution condition has been satisfied from the controller 32, may send an instruction to replace the delivery box 20 to the terminal 12 of the operator.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for managing a delivery box located at a predetermined receiving station, the delivery box including storage sections and locks, the storage sections each configured to store a package, the locks each configured to lock and unlock a corresponding one of the storage sections, the method comprising:
determining, with processing circuitry, whether a replacement execution condition is satisfied, the replacement execution condition being satisfied when a number of the storage sections that store packages in the delivery box located at the receiving station is less than or equal to a predetermined number; and
when the replacement execution condition is satisfied, sending, with the processing circuitry, to a terminal of an operator an instruction to replace the delivery box located at the receiving station with a new delivery box.

2. The method according to claim 1, wherein a number of empty storage sections in the new delivery box is greater than or equal to the predetermined number.

3. The method according to claim 2, further comprising:
temporarily granting, with the processing circuitry, lock information of the old delivery box to the operator who replaces the old delivery box with the new delivery box,
wherein the locks are configured to be unlocked through authentication of the lock information.

4. The method according to claim 1, further comprising:
sending, with the processing circuitry, to the terminal of the operator an instruction to move the old delivery box from the receiving station to a delivery base; and
notifying, with the processing circuitry, a recipient of the package that is still stored in the old delivery box that the package is at the delivery base.
